(19) United States
(12) Patent Application Publication
(10) Pub. No.: US 2017/0222388 A1
(43) Pub. Date: Aug. 3, 2017

(54) High Air-Tightness Device

(71) Applicant: Yaowu Ma, Zhengzhou (CN)

(72) Inventors: Yaowu Ma, Zhenghou (CN); Fen Ruan, Zhenghou (CN); Jun Ma, Zhengzhou (CN); Pinzhen Huang, Zhengzhou (CN); Qianjing Ma, Zhengzhou (CN); Qianjia Ma, Zhengzhou (CN); George Ma, Zhengzhou (CN)

(21) Appl. No.: 15/119,706

(22) PCT Filed: Feb. 14, 2015
(86) PCT No.: PCT/CN2015/073073

§ 371 Date: Jan. 13, 2017

(30) Foreign Application Priority Data
Feb. 24, 2014 (CN) 201410060566.3

(51) Int. Cl. H01S 3/02; F16J 15/08

(52) U.S. Cl. CPC H01S 3/02; F16J 15/0893

(57) ABSTRACT

A high air-tightness device is provided with a bottom plate (1), a frame body wall (2) and a shell body cover (3). The materials of said parts are one and more of metal, glass and ceramic, and the junctions among the parts are sealed by extruding a hollow-core metal sealing ring (12) by thread. The device is provided with one and more of a window glass (17), a pipeline (10), a pipeline interface, an openable and closable valve (11), an electrode communicating inside with outside and a threaded opening, and the device is connected and sealed by extruding the hollow-core metal sealing ring using the internal or external threaded part to move straight or rotate; or the device is pre-sealing formed by one and more of a metal solder welding processing technique, a metal welding processing technique, a glass welding processing technique and a sintering ceramic formed processing technique. The materials of each part for isolating inside from outside during the sealing are one and more of metal, glass and ceramic. Vacuum, special gas and liquid can be sealed within the high air-tightness device for a long time. The high air-tightness device is easy to be opened and re-sealed, and has easy maintenance and low cost.

### FIELD OF THE INVENTION

The present invention relates to a high air-tightness device, and more particularly to the sealing for high air-tightness electromechanical device, laser, vacuum device, high air-tightness container, sensor, high temperature or low temperature device, air conditioner, engine, etc.

### BACKGROUND OF THE INVENTION

Electromechanical device is widely used in industry, agriculture, health care and other fields, and has many types, such as laser, lighting source, camera, video camera, computer, database storage, telephone, oscilloscope, multimeter, communication equipment, electrical signal processor, microwave component, sensor, air conditioner, high temperature furnace and ultra-low temperature cooling device, which are the electromechanical devices often used. Among these electromechanical devices, some do not need to seal, some must be sealed and some will produce better performance if sealed.

Some sealing are not easy to remove, such as welding sealing and adhesive sealing. There are also a lot of sealing which require easy removing for repair, and to be sealed again after the repair. The sealing method for a device container usually refers to the sealing method for the container lid. If there is no pipeline, this is the final sealing step of the container. If there is a pipeline, generally after the lid is sealed, the container is vacuumized or a special gas is injected into the container through the pipeline, and finally the pipeline is sealed. The sealing using rubber sealing ring is one of the most widely used sealing, therefore in the case of unspecified, the material of O-shaped sealing ring is generally considered to be rubber material. The sectional structure of the rubber sealing ring is mostly solid-core circular shape and solid-core rectangular shape, therefore in the case of unspecified, the sectional structure of the sealing ring is generally considered to be solid-core structure. As a kind of electromechanical device, laser is a device that allows light to be emitted with amplification or oscillation in certain stimulated substances using the principle of stimulated radiation. Laser is a relatively sophisticated electromechanical device, and usually needs to be sealed. Patents CN100474715C, CN101064408A and JPA_2007294807 use O-shaped sealing rings to seal the gas lasers. Patent CN202393699U uses O-shaped sealing ring to seal the laser pipeline. Patent CN102780144A uses the sealing material of latex bar or O-shaped sealing ring to seal the laser box. Patent CN203162385U uses internal thread and external thread to press the O-shaped sealing ring to seal the laser pipeline interface. Patent JPA_1996340138 uses O-shaped sealing ring to seal the laser, however, the O-shaped sealing ring made of rubber material is prone to aging under the intense light of the laser, so a light-blocking ring made of indium, a soft metal material, is mounted around of the O-shaped sealing ring to block the intense light of the laser, thereby preventing the O-shaped sealing ring from exposure to the intense light. Here, the light-blocking ring made of metal material of indium does not work on the sealing for gas or liquid. Patents U.S. Pat. No. 7,257,003B3 and JP2003-69270A use rubber material to seal the electronic unit housing.

Although widely used, the rubber sealing ring, in the case of high requirement for air-tightness, is not suitable for high air-tightness sealing, since the gas leakage of the rubber material itself is too severe. Laser is the light-emitting device with high energy density and high precision, therefore, in order to maintain stable performance, some lasers need sealed container of ultra-low leakage, and with special gas sealed inside, such as nitrogen, inert gas and the like. And the gas laser only works in the presence of special gas. Metal, glass and ceramic are materials with good air-tightness, namely materials with very low leakage. Other materials such as plastics and other organic materials have poor air-tightness. If the component material and the sealing interface of the laser housing are metal, glass and ceramic, good air-tightness can be obtained. If the laser also has other packaging materials, the sealing effects of these materials are not considered. Such sealing method is referred to as air-tightness sealing herein. The sealing method using rubber ring, plastic or adhesive is not referred to as air-tightness sealing herein, since its air-tightness is several orders of magnitude poorer.

TO-Can and butterfly-shaped laser both have container materials with good sealing performance, such as metal, glass and ceramic, and also have packaging process with good sealing performance, such as welding. Patents US20140022718 and DE102005041751A1 illustrate different types of vacuum-sealed packaging using welding. The common features of these lasers and vacuum-sealed packaging are welding seal. The sealing performance of welding is pretty good, allowing it to be widely used in electronic products. However, as for the welding seal, it is not easy to open the sealed housing, or seal the housing again after the repair. Fortunately, many lasers, such as TO-Can and butterfly housing are small size, simple structure, mass production and affordable price. If there is a failure, they are generally not repaired, but are replaced.

However, for lasers with large size, complex structure and high cost, repair is necessary. Welding seal is not suitable for use due to the difficulty of opening and re-sealing. Therefore, the sealing performance of existing large lasers is not very good. Some of the large lasers use rubber ring or adhesive to seal, and obtain the performance of easy opening and re-sealing. But the sealing method using rubber ring and adhesive has the problem of severe air leakage, which is several orders of magnitude greater than the sealing method using metal welding. Therefore, the sealing performance, stability and service life of the large laser sealed by rubber ring or adhesive are all much poorer than those of the laser sealed by welding. And as for some other large lasers, rubber ring is used to facilitate repair, resulting in poor sealing performance, however, in order to obtain a good working condition, the working container is connected with a vacuum pump, or air pump, thus taking the initiative to forcibly achieve vacuum or special gas environment. This could work, but the cost for long-term maintenance is very high.

In addition, frequency-doubled component and amplification component of almost all solid lasers, as well as the resonant cavity of many gas lasers basically do not use welding seal, but use rubber ring to make the box structure which is easy to open and re-seal, since the box needs to be opened frequently to carry out maintenance and repair. Wherein, many of the internal parts are in place through adjustment. In the perfectly adjusted position, if not locked, the part has relatively poor stability. If locked, how to maintain reliability and convenience needs a lot of techniques. For example, locking with adhesive is an easy and convenient method commonly used. However, when many adhesives encounter with moisture and other gases, their shape will change, which undermines the perfectly adjusted position. Because these housings are not air-tightly sealed, moisture is easy to enter the inside of the housing, affecting the stability of the laser. In general cases, when the stability decreases, the box is opened to make adjustment, and after the adjustment is completed, the housing is sealed with the rubber ring. Since the sealing performance of the rubber ring is poor, the stability is not good, either. So it needs to be adjusted and maintained very often, thus resulting in high maintenance cost.

Because of the small air leakage of metal material, patent CN201001001Y uses the metal sealing ring to seal the laser, and the air-tightness is improved. However, the sectional structure of the metal sealing ring has solid core, so the glass material can not apply a lot of pressure when pressing. Use of glass material to press the sealing ring made of hard material, such as stainless steel, is difficult to obtain good air-tightness, so the material of the metal sealing ring is limited to the soft metal materials, such as indium, gold, aluminum and so on.

As for solid-core metal sealing ring, for example, the sealing ring with sectional structure being circular or rectangle, its elastic deformation is very small when pressed, and the restorable elastic deformation is also small when pressure reduces, therefore, under the circumstances of heat expansion, cold contraction, or vibration, the sealing performance may become worse. For stainless steel and other hard materials, they need large pressure, but it is difficult to implement. Therefore, there are only a few examples of using solid-core metal sealing ring for sealing. In order to overcome this shortcoming, patent CN202851945U has invented a self-tightening C-shaped metal sealing ring. Patent CN203463645U invented another metal sealing ring. The sectional shapes of the two metal sealing rings are not solid, but have hollow-core structures. Due to the hollow-core structure, the elastic deformation becomes large when pressed, therefore, for stainless steel and other hard materials, pressure can be much smaller, thus easy to implement. The hollow-core metal sealing ring does not need large pressure to fill the gap for sealing. The hollow-core metal sealing ring can be made into a proper shape, and is composed of different types of hard and soft metals. When sealing, the soft metal can fill the gap to seal, and the hard metal has flexibility to adapt to the change of the gap, when there is vibration and the pressure changes over a long time. Patent CN201615230U provides an elastic metal sealing ring, i.e. a hollow-core metal sealing ring, on a valve body or a valve plate of a butterfly valve, to achieve the sealing when the butterfly valve is closed. The cross section of the elastic metal sealing ring is a circular ring shape or a U-shape. However, the butterfly valve has a turning plate structure, and does not press the sealing ring in a plane. The pressing of the butterfly valve is in the direction of radius at the circumferential edge, and there is friction as pressing. The friction is easy to produce scratches, therefore, it is difficult to obtain good air-tightness.

Patent CN102606823B uses hollow-core metal sealing ring to carry out sealing connection, and describes in detail the constructing material and other features of the hollow-core metal sealing ring, which is suitable for the sealing of the radioactive material and the chemical article. However, it does not mention how to obtain a well-sealed container and device. Patent U.S. Pat. No. 4,477,087A illustrates using a hollow-core metal sealing ring to seal the laser. The optical mirror of the resonant cavity of the laser is used to press the hollow-core metal sealing ring to seal, but the material properties of the mirror glass and the metal are different, so the sealing effect is limited.

Using hollow-core metal sealing ring to seal can obtain many good properties, for example, the metal material made of hollow-core metal sealing ring has slow aging speed and long service life, and can work under high temperature and low temperature for a long time, therefore in some cases it has good air-tightness. However, the use of hollow-core metal sealing ring to seal is a cumbersome task. The hollow-core metal sealing ring is much more expensive than the rubber ring, and is a relatively new thing, thus not easy to get or purchase. The sealing performance of the hollow-core metal sealing ring will decline due to metal rust. When the hollow-core metal sealing ring is used to seal, the specific characteristics of the hollow-core metal sealing ring need to be known very well, and there are strict requirements for the structure of pressing the hollow-core metal sealing ring, the material of the pressing components, the shape accuracy of the pressing components, such as flatness and roughness. If there is a mistake made in one of the technical details, the sealing effect may be much worse than expected, and even worse than the effect produced by using rubber ring. In contrast, for the use of a rubber ring to seal, the various requirements for details are relatively loose, and is easy to achieve the desired effect of sealing. Therefore, the use of hollow-core metal sealing ring for sealing is not easy to popularize, and although it has been invented for many years, in a wide range of uses, it does not achieve good results easily in short time, and a variety of improvements have cost a lot of time.

At present, air-tightness device, such as small laser, which basically do not need to repair by opening the housing, uses welding sealing to seal and obtain good air-tightness, good stability and long service life. The technique is mature and has been widely in use. Considering the need to open the housing for repair, electromechanical device, such as large laser, generally uses rubber ring and adhesive to seal, resulting in poor air-tightness, poor stability, and short service life. Sometimes, large lasers and other electromechanical devices also use solid-core or hollow-core metal sealing ring for sealing, but the technique is not mature, and the air-tightness effect is not good enough, thus requiring further improvement. Also, if the air-tightness effect is improved, the stability of large electromechanical device will also become better, and the service life will be longer.

### SUMMARY OF THE INVENTION

In order to solve the deficiencies in the prior art, the present invention provides a good sealing container and device which has good sealing performance, is easy to open, can ensure good air-tightness when re-assembled after opened, and can implement and maintain a vacuum or suitable gas environment.

In order to solve the above technical problem, the present invention adopts the hollow-core metal sealing ring to carry out the sealing of the container device. Prior to this, the material of each component insulating the inside from the outside of the sealing container of the device is designated as metal, glass, and ceramic materials. When necessary, all components can be pre-assembled to be formed integrally, and the technique of pre-assembly is designated as metal solder welding processing technique, metal welding processing technique, glass welding processing technique, ceramic sinter forming processing technique and hollow-core metal sealing ring pressing sealing technique. In particular, the present invention adopts the following technical solution:

High air-tightness device comprising:

bottom plate, frame wall and lid components forming sealed container, and hollow-core metal sealing ring,

wherein said components press said metal sealing ring in a plane to make sealing with threaded components in one or more junctions between said components,

while other junctions between said components are sealed in advance during pre-assembly or pre-forming by using one or more of metal solder welding processing technique, metal welding processing technique, glass welding processing technique, and ceramic sinter forming processing technique,

and said components are metal material.

One or more of said components are glass or ceramic material with pre-plated or pre-welded metal material in contact surfaces pressing said metal sealing ring.

High air-tightness device according to claim 1, wherein said bottom plate, frame wall and lid are provided with one or more of window glass, pipeline and thick electrode and fine electrode communicating inside with outside, the materials of these components and of the junctions with said bottom plate, frame wall or lid are one or more of metal, glass and ceramic, and said junctions are sealed in advance during pre-assembly or pre-forming by using one or more of the metal solder welding processing technique, metal welding processing technique, glass welding processing technique, ceramic sinter forming processing technique and hollow-core metal sealing ring pressing sealing technique.

Said bottom plate and said frame wall are an integrally formed component, or said frame wall and said lid are an integrally formed component.

One or more of said bottom plate, frame wall and lid comprise one or more of internal threaded blind hole and external threaded blind hole which are used for installation of internal and external elements and components.

High air-tightness device comprising:

pipeline interface with external thread and internal threads of metal material and hollow-core metal sealing ring,

wherein said device uses said external thread and internal thread to propel moving components in a straight or rotary manner, and uses plane to press said hollow-core metal sealing ring, to perform connection sealing of said pipeline interface.

High air-tightness device comprising:

an operable and closable valve, wherein the materials of each component for isolating inside from outside of said valve when said valve is closed are one or more of metal, glass and ceramic with pre-plated or pre-welded metal material in contact surfaces pressing hollow-core metal sealing ring, and said device uses external thread and internal thread to propel or electrically propel moving components of said valve in a straight or rotary manner, and uses plane to press or loosen said hollow-core metal sealing ring inside of said valve, in order to close or open said valve.

Said valve comprises a rubber ring, and when said valve is opened hermetically, said rubber ring is used for temporary sealing.

Said valve has a knob switch, by loosening said switch, said hollow-core metal sealing ring is taken out from said valve.

High air-tightness device comprising:

sheet metal component, sheet metal stamping component, glass plate component which is pre-plated or pre-welded with metal material in contact surfaces pressing hollow-core metal sealing ring, hollow-core metal sealing ring and pressing amount limiting base plate,

wherein two of said components press and seal said hollow-core metal sealing ring with threaded components, as the packaging for sealed container,

and said pressing amount limiting base plate limits the pressing amount of said hollow-core metal sealing ring.

Said pressing limiting base plate is a whole plate, or several base plates with minor segments.

Said pressing limiting base plate is integrally pre-fixed with said sheet metal component, sheet metal stamping component or glass plate prior to pressing sealing.

High air-tightness device comprising:

external or internal threaded opening component, hollow-core metal sealing ring,

wherein said opening components use the internal and external thread to press said hollow-core metal sealing ring by a plane to form a sealed container,

and the materials of said container components for isolating inside from outside of the container when sealing are one or more of metal, glass and ceramic which is pre-plated or pre-welded with metal material in contact surfaces pressing said metal sealing ring.

One or more of the positions between said external or internal threaded opening components and said hollow-core metal sealing ring, and between said hollow-core metal sealing ring and said corresponding internal or external threaded components have gaskets of metal, glass and ceramic which is pre-plated or pre-welded with metal material in contact surfaces pressing said metal sealing ring.

One or more of the positions between said external or internal threaded opening components, said gaskets and said corresponding internal or external threaded components have keys or grooves, and through the matching of said keys and grooves, when said external or internal threaded opening components and said corresponding internal or external threaded components are rotated to be tightened or loosened, said gaskets and said hollow-core metal sealing ring only have straight motion of pressing or leaving, and have no relative rotation.

Said gaskets are edges of pipeline.

Said external or internal threaded opening is one or more of threaded opening of bottle or tank container, threaded orifice of pipeline, inlet of electrode and mounting opening of window glass.

Said external or internal threaded opening component is the component of a pipeline having edges in addition to a hollow screw thread.

The sealing process of said pipeline outside said device is heating to melt, clamping off, or connecting said valve to close.

Said hollow-core metal sealing ring is one or more of C-shape, spring-enhanced C-shape, E-shape, W-shape, O-shape, U-shape and V-shape.

One or more of vacuum, special gas, nitrogen, inert gas, refrigerant gas and liquid, liquid and laser gain medium are sealed within said device.

Two or more of said high air-tightness devices are connected and sealed through the use of one or more of said pipeline, said pipeline interface, said hollow-core metal sealing ring and said valve.

### BRIEF DESCRIPTION OF THE DRAWINGS

FIG. 1 is an oblique view of a high air-tightness electromechanical device of the present invention in one direction.

FIG. 2 is an oblique view of the device of FIG. 1 in another direction.

FIG. 3 is a cross-sectional view of the device of FIG. 1.

FIG. 4 is a schematic view of the structure of C-shaped hollow-core metal sealing ring in FIG. 3.

FIG. 5 is a cross-sectional view of the sealing ring in FIG. 4 without pressing.

FIG. 6 is a cross-sectional view of the sealing ring in FIG. 4 with pressing.

FIG. 7 is a schematic view of the structure of a part of the spring-enhanced C-shaped hollow-core metal sealing ring in FIG. 3.

FIG. 8 is a cross-sectional view of the sealing ring in FIG. 7 without pressing.

FIG. 9 is a cross-sectional view of the sealing ring in FIG. 7 with pressing.

FIG. 10 is a schematic view of the structure of the device of the Fig. I with the lid open and the pipeline and the valve removed.

FIG. 11 is a schematic view of the structure of the device of FIG. 1 with the lid open when seen from the bottom.

FIG. 12 is a schematic view of the structure of the valve of the present invention.

FIG. 13 is a cross-sectional view of the valve in FIG. 12.

FIG. 14 is a schematic view of the structure when the knob switch is separated from the valve in FIG. 12.

FIG. 15 is a schematic view of the structure of the connection between the valve and the pipeline interface of the present invention.

FIG. 16 is a schematic diagram of the structure of a high air-tightness electromechanical device with no windows of the present invention.

FIG. 17 is a schematic diagram of the structure of a high air-tightness electromechanical device with solar charging or wireless charging of the present invention.

FIG. 18 is a schematic diagram of the structure of a high air-tightness electromechanical device with a thin-walled frame of the present invention.

FIG. 19 is a schematic diagram of the structure of the high air-tightness device made of sheet metal and sheet metal stamping components of the present invention.

FIG. 20 is a cross-sectional view of the sealing structure of FIG. 19.

FIG. 21 is a schematic diagram of the structure of the high air-tightness device made of glass plate and sheet metal stamping components of the present invention.

FIG. 22 is a cross-sectional view of the sealing structure of. FIG. 21.

FIG. 23 is an exploded view of a high air-tightness container of the present invention.

FIG. 24 is a cross-sectional view when the container of FIG. 23 is assembled and sealed.

FIG. 25 shows that a pipeline is provided on the gasket of FIG. 23.

FIG. 26 shows a gasket having a pipeline and a key.

FIG. 27 is a schematic diagram of the structure of the high air-tight butt joint of the two pipelines through the pressing of the hollow-core metal sealing ring of the present invention.

### DETAILED DESCRIPTION OF THE INVENTION

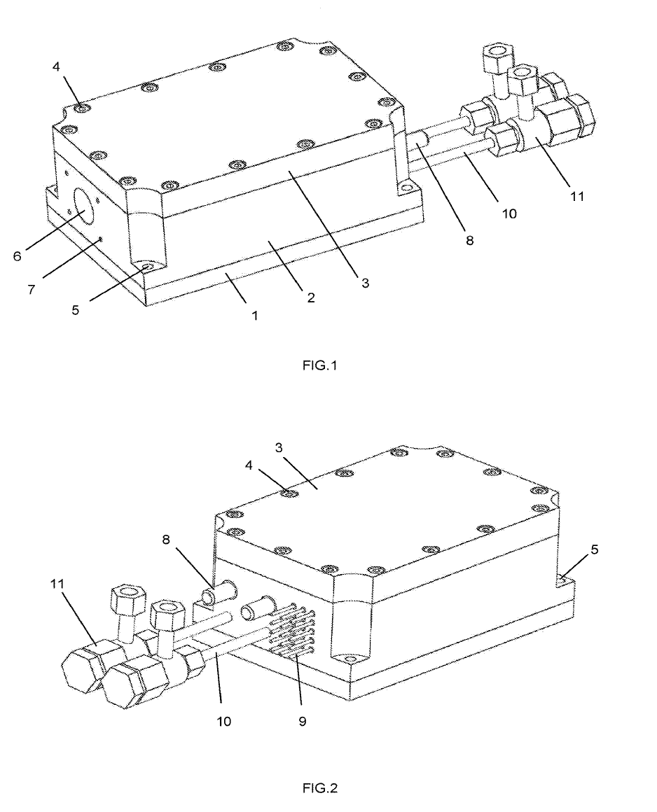

FIGS. 1 and 2 are oblique views of a high air-tightness electromechanical device of the present invention in two different directions. The sealing housing of the device is mainly composed of a bottom plate 1, a frame wall 2 and a lid 3. A screw 4 tightly fixes the lid 3 on the frame wall 2. The four corners of the frame wall 2 have four holes 5, which can be used to fix the electromechanical device on other brackets by screws.

When the electromechanical device is a laser, the laser light generated inside the device is output through window 6. The output laser light may need to be coupled to the optical fiber, so screw holes 7 are provided on the frame wall 2, so as to fix the coupling mechanism. The screw hole 7 is a blind hole, not a through-hole connecting the inside and outside of the housing, so the screw hole 7 does not affect the sealing performance of the housing.

Elements and components of the laser is put into the device. These elements and components usually include crystal, glass, metal, temperature control element, temperature monitoring element, humidity monitoring element, and optical power monitoring element, etc. These elements and components are usually fixed within the housing through screws, welding and adhesives. For the laser, the power supply and the electric signal are connected with the elements and components inside of the laser from outside through the thick electrode 8 and the fine electrode 9. The large current passes through the thick electrode 8 and the small current passes through the thin electrode 9.

In many cases, if the sealing housing of the laser has been always filled with nitrogen, inert gas or vacuum, then the life time of the laser will increase a lot. If the final sealing process of the junction between the bottom plate 1, frame wall 2 and lid 3 is carried out in another big box filled with desired gases or vacuum, such as a glove box, the desired gases or vacuum is sealed within the housing.

The sealing of the junction between the bottom plate 1, frame wall 2 and lid 3 is usually easier to do under ordinary air condition. At this time, after the sealing, the desired gases can be injected into the housing or the housing can be vacuumized through the pipeline 10 connected to the housing. Then the pipeline 10 is clamped off, heated to melt, or closed by the valve 11.

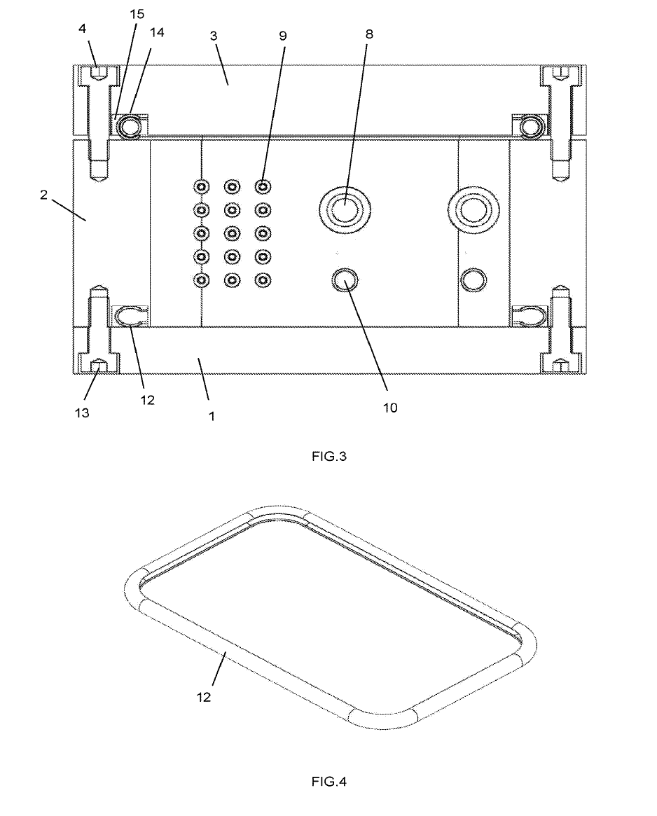

FIG. 3 is a cross-sectional view of the sealing housing of the electromechanical device, so as to illustrate the air-tightness sealing of the bottom plate 1, frame wall 2 and lid 3. In order to obtain good air-tightness, the component materials of the bottom plate 1, frame wall 2 and lid 3 are metal, glass and ceramic. The surfaces of these components can be painted, but the sealing effect of the painting will not be considered here. A C-shaped hollow-core metal sealing ring 12 is placed between the bottom plate 1 and the frame wall 2. The C-shaped ring 12 is a flexible metal material. In order to obtain a good sealing effect, the C-shaped ring can be polished on surface, and plated with gold, silver, copper, tin and other soft metal materials. The surfaces of the bottom plate 1 and the frame wall 2 contacting the C-shaped ring likewise remain metal, glass and ceramic materials, with little roughness and great flatness, and cannot have painting. As such, the pressurization of the screw 13 can allow for good contact between the C-shaped ring 12 and the surfaces of the bottom plate 1 and the frame wall 2, and the leakage rate of helium can be as little as 1×10⁻¹² Pa m³/sec per mm of hollow-core metal sealing ring length. For 100 mm length of hollow-core metal sealing ring, the value is 1×10⁻¹⁰ Pa m³/sec, approximately equal to 1×10⁻⁹ atm cc/sec, whose physical meaning is that: under 1 standard atmospheric pressure difference, the helium leaks 1 cc every 30 years, or air leaks about 1 cc every 80 years.

The material used to press the contacting surface of the C-shaped hollow-core metal sealing ring 12 and the bottom plate 1 and the frame wall 2 should be preferably the soft material same as that of the surface of the C-shaped hollow-core metal sealing ring 12. Then through pressing, the contact surface material of the bottom plate 1 and the frame wall 2 and the surface material of the C-shaped hollow-core metal sealing ring 12 are prone to be integrally blended together at the interface, resulting in best sealing effect of the interface. The interface of the same kind of soft metal material are prone to be integrally blended. While the interface of different kinds of metal materials are not so prone to be integrally blended. The interface of the metal material, glass and ceramic are hard to be integrally blended, due to the great difference of the material characteristics, therefore the sealing effect of the interface is relatively poor. At this time, metal material same as that of the surface of the C-shaped hollow-core metal sealing ring 12 can be pre-plated or pre-welded with metal material at the pressing contact surface of the glass or ceramic material. Plating or welding can tightly attach the metal material on the glass or ceramic, allowing for good air-tightness of the interface. Metal and metal are pressed together, and the interface is prone to be integrally blended, thus having good air-tightness, Even though the bottom plate 1 and the frame wall 2 are made of metal materials, plating or welding appropriate metal materials on the contact surface can also facilitate to improve the air-tightness effect.

A metal spring-enhanced C-shaped ring 14 is placed between the frame wall 2 and the lid 4 of FIG. 3. The sealing performance of the metal spring-enhanced C-shaped ring 14 is one order of magnitude better than the C-shaped ring 12. The metal spring-enhanced C-shaped ring 14 is placed within the annular groove 15 of the lid 3. FIG. 3 shows the non-pressing status. When the screw 4 is tightened, the cylindrical spiral spring is pressed into an elliptic cylinder.

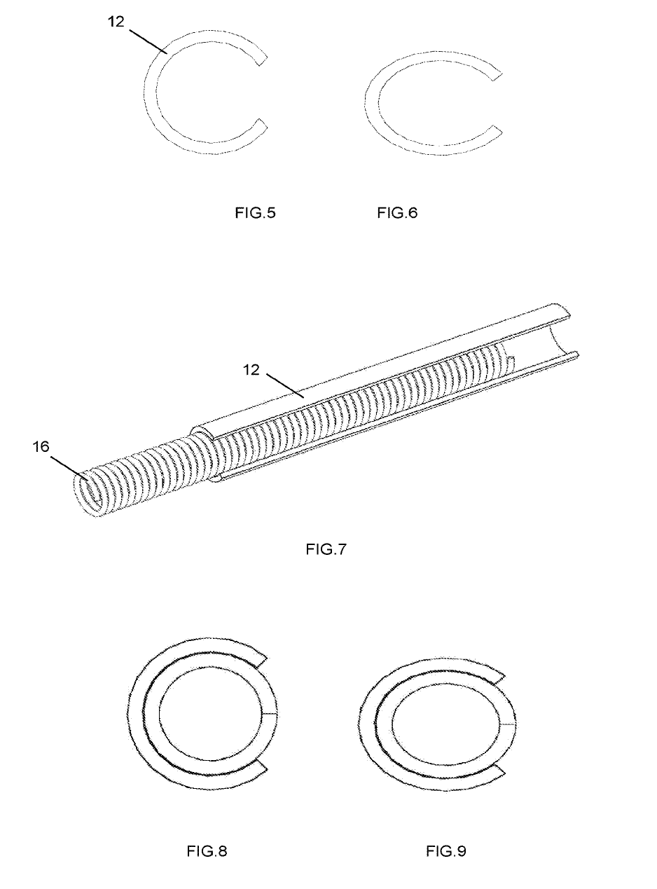

FIG. 4 is a schematic view of the structure of C-shaped hollow-core metal sealing ring 12 without pressing, its sectional structure is as shown in FIG. 5, and when pressed, its sectional structure is as shown in FIG. 6.

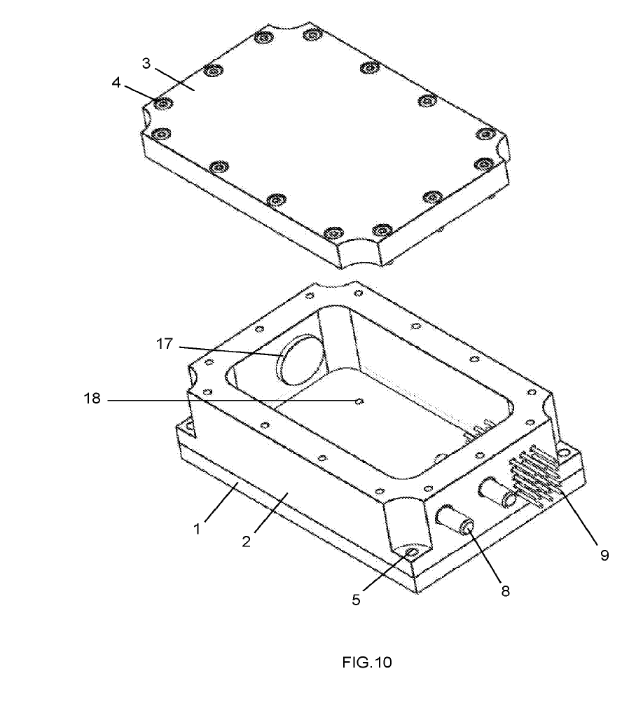

FIG. 7 is a part of the spring-enhanced C-shaped ring 14. It is made up of C-shaped ring 12 and spiral spring ring 16 which is disposed through the C-shaped ring. FIGS. 8 and 9 show the sectional shapes without pressing and with pressing, respectively. The spiral spring ring 16 facilitates to adapt to the uneven surfaces of the frame wall 2 and the lid 3 in the length direction.

There are many kinds of hollow-core metal sealing ring, and based on the sectional shape, there are O-shape, W-shape, E-shape, U-shape, V-shape, super C-shape, etc., which can be used for the purpose of the present invention, and when selected, its sealing performance, pressure and other parameters should be considered.

In order to simplify the sealing and reduce the cost of housing, the bottom plate 1 and the frame wall 2 can be made into an integral component, or the frame wall 2 and the lid 3 can be made into an integral component.

The thick electrode 8 and the fine electrode 9 generally need to be integrally formed with housing, such as the frame wall 2 and the lid 3, respectively, with its interface requiring good sealing performance. The sealing method of the rubber ring and the adhesive can not be used, due to their poor sealing performance. The method of heat welding should be used, such as metal solder welding, metal welding, glass welding and ceramic sinter forming, etc. Here, the metal solder welding uses metal solder, the melting temperature of which may be high or may be low, corresponding to the low temperature tin welding, high temperature braze welding, etc. The solder welding process includes soldering iron welding, flame welding, heating furnace welding, etc. The metal welding does not use solder, including fusion welding, diffusion welding etc.

The pipeline 10 generally also needs to be integrally formed with the housing, and the sealing method can not use the rubber ring, plastics or adhesives but need to use heat welding method, such as metal solder welding, metal welding, glass welding and ceramic sinter forming, etc. The pipeline 10 can be made of metal or glass. After filled with the desired gases or vacuumized, the pipeline 10 of metal material or glass material is melted and compacted for sealing.

A part of the pipeline metal materials such as copper and aluminum can also be sealed by simply clamping off the pipeline 10. When the pipeline 10 is clamped off the metal material pipeline 10 is first pressed into a small gap. Then continuing to press, the metal material has a large plastic deformation, and the metal materials on both sides of the gap are cold welded together, and the gap will disappear. This clamping-off sealing method has a good sealing performance.

In addition to the above sealing of melting and compacting and clamping off the pipeline 10 can also be sealed by valve 11, so that it can be opened and then re-sealed for many times. The connection sealing of the valve 11 and the pipeline 10 can be heat welding sealing, pressing sealing by hollow-core metal sealing ring, or they may be integral component beforehand.

FIG. 10 is a schematic view of the structure of the high air-tightness electromechanical device of the FIG. 1 with the lid open and the pipeline and the valve removed. The window 6 is provided with a transparent window glass 17 which separates the inside and the outside of the housing. Laser light generated within the housing is output through the transparent window glass 17 and the window 6. The sealing between the transparent window glass 17 and the housing, such as the frame wall 2 and the lid 3, requires a good sealing method. The sealing method of the rubber ring and the adhesive can not be used, and the method of heat welding should be used, such as metal solder welding, glass welding and ceramic sinter forming, etc. When the transparent window glass 17 is the glass with melting point not too high, the sealing method of metal solder welding and glass welding can be used. The frame wall 2 and the lid 3 are generally metal, and when using metal solder to weld glass, the glass surface is generally plated with metal film to metallize the glass, so that the soldering material can firmly weld the glass. When the window glass is a corundum material with melting point up to 2040° C., the sealing method of ceramic sinter fowling can also be used. The ceramic sintering temperature is usually lower than 2000° C., and will not fuse the corundum material.

FIG. 10 also shows an internal thread blind hole 18 on the bottom plate 1. The thread blind hole 18 is used to fix the elements and components inside the housing. Based on the requirements, the thread blind hole 18 can also be disposed on the frame wall 2 and the lid 3. The thread blind hole 18 is not through-hole, and does not affect the sealing of the housing. In addition to fixed with screws, the internal elements and components can also be fixed by welding and adhesives. Unlike FIG. 1, FIG. 10 shows the state with no need for the pipeline 10 and valve 11.

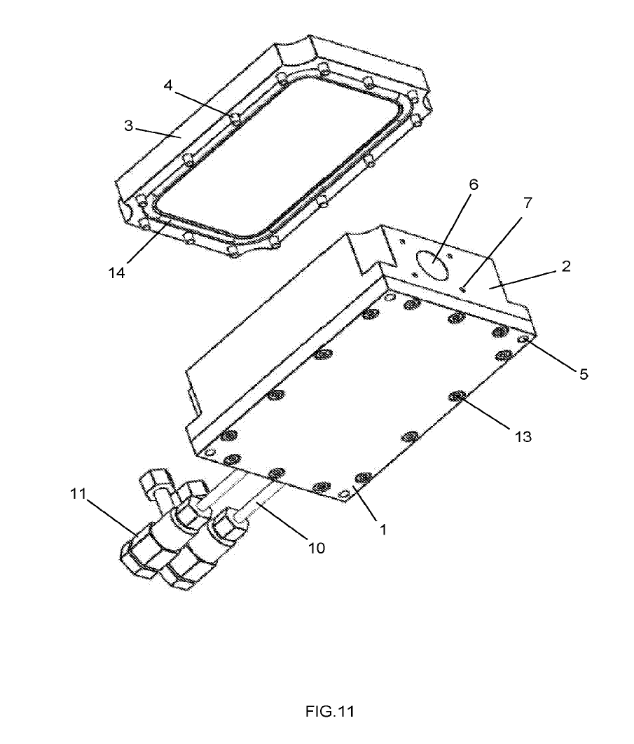

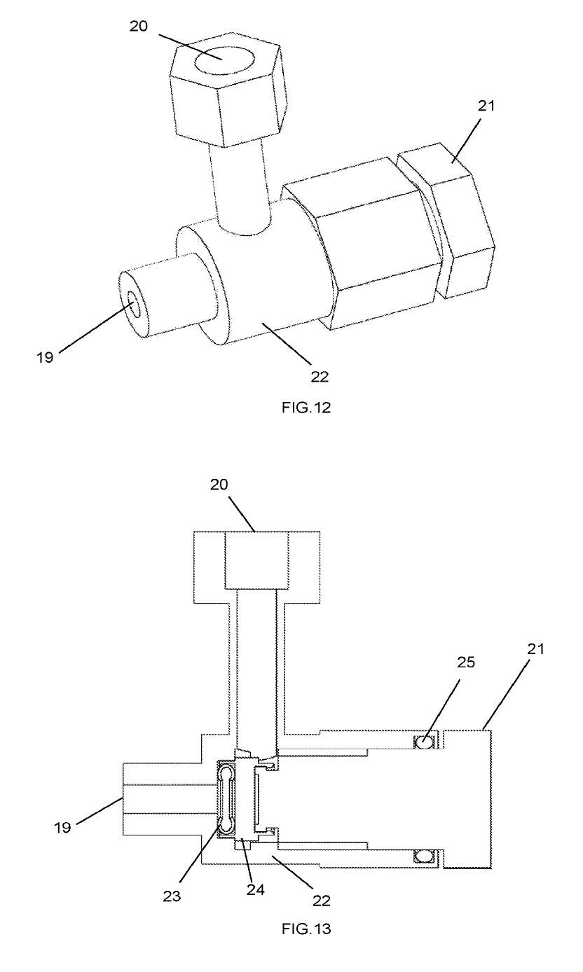

FIG. 11 shows the housing with the lid 3 open when seen from the bottom of FIG. 1. The sealing metal ring 14 is placed in the annular groove 15 at the lid 3. As another method, the annular groove can also be disposed at the frame wall 2.

The bottom surface of the bottom plate 1 shown in FIG. 11 is flat, except for the screw hole of the screw 13. Since some of high-power electromechanical devices need to be cooled from the bottom plate 1, the flat bottom surface is favorable for the heat transferred to other cooling plates. As for some other high-power electromechanical devices, the bottom plate 1 is provided with waterway, and the cooling water flows in the waterway, taking the heat away.

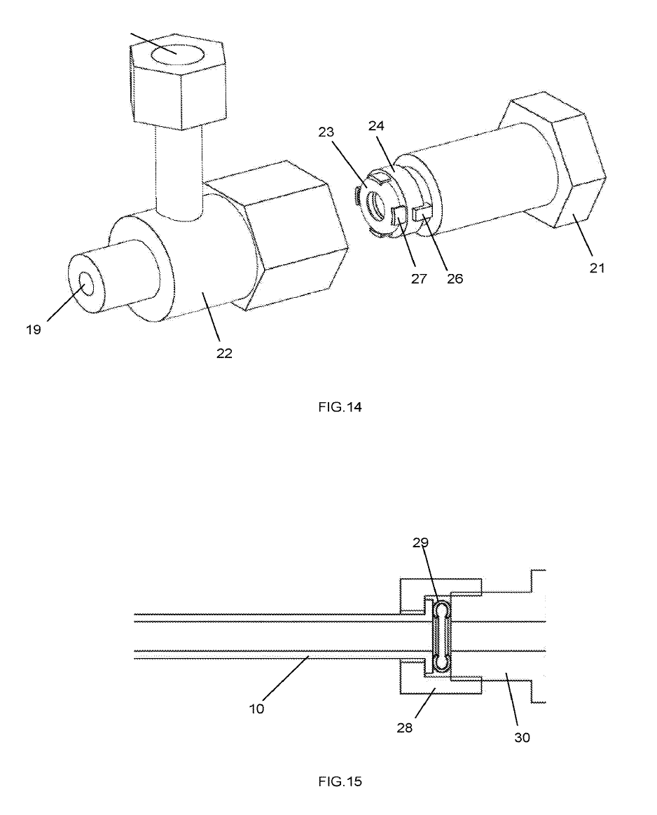

The valve 11 requires a good sealing performance herein. The conventional valve use rubber ring to seal, which can not be used herein. The present invention provides a valve with high air-tightness, as shown in FIGS. 12 and 13. 19 and 20 is the inlet and outlet of the valve pipeline, 21 is valve knob, 22 is valve body, 23 is hollow-core metal sealing ring, 24 is pressing block, and 25 is rubber sealing ring. The material of each component isolating the inside from the outside of the valve when the valve is closed is one or more of the metal, glass and ceramic. When tightening the knob switch 21, the knob switch 21 propels the pressing block 24 to move straight to press the C-shaped sealing ring 23. The pressing block 24 is provided with a guide key 26, as shown in FIG. 14. The guide key 26 is matched with the guide groove of the inner cylinder of the valve body 22, so that the pressing block 24 can only move straight, without rotation. When the pressing block 24 pressed the C-shaped sealing ring 23, the air-tightness of leakage rate of helium less than 1×10⁻¹⁰ Pa m³/sec can be achieved. If the guide key 26, the guide groove and the pressing block 24 are omitted, the valve can have the advantages of simple structure and low cost, but the hollow-core metal sealing ring 23 turns to be subjected to rotary pressing, resulting in large wear, and generally does not have such good sealing performance as straight pressing under the guide key.

When loosening the knob switch 21, the pipeline inlet 19 and outlet 20 get through with each other. In order not to cause too much air leakage at the knob switch 21, a rubber sealing ring 25 is disposed on the periphery of the cylinder of the knob switch 21. When the pipeline inlet 19 and outlet 20 get through with each other, the external air pump or high pressure air cylinder control the air state inside the housing, so that the leakage rate of the rubber sealing ring 25 being a bit high is not so important.

FIG. 14 is a state diagram with the knob switch 21 and the valve body 22 separated. When the knob switch 21 is loosened to a certain extent, the knob switch 21, pressing block 24 and C-shaped sealing ring 23 are taken out from the inner cylinder of the valve body 22 altogether. The C-shaped sealing ring 23 is stuck within four anti-detachment claws 27 on the pressing block 24. At the same time, the pressing block 24 is also stuck on the knob switch 21. Sometimes, in order to ensure high air-tightness, the hollow-core metal sealing ring 23 can only be sealed once, and if need to seal again, the hollow-core metal sealing ring 23 should be replaced with a new one. With regard to the valve of the present invention, the hollow-core metal sealing ring 23 used for sealing can be simply taken out from the valve body 22, facilitating replacement. In order to prevent the separation of the knob switch 21 assembly from the valve body, a separation preventive screw can be disposed on the valve body. When the separation preventive screw is tightened, the rotation of the knob switch 21 can only close or open the valve. When the separation preventive screw is loosened, the rotation of the knob switch 21 can allow it be taken out from the valve body.

The knob switch 21 shown in FIGS. 12 to 14 is a manual mechanical type, and for electric valve, the knob switch can be made into electric type. The electric switches have rotary and straight types, and for the straight electric switch, the guide groove and the pressing block 24 in the valve both can be omitted.

In the present invention, the junction between the valve 11 and the pipeline 10 also use pressing sealing by hollow-core metal sealing ring to achieve high air-tightness. The material of each component isolating the inside from the outside of the pipeline interface when the pipeline interface is connection sealed is one or more of metal, glass and ceramic. FIG. 15 shows a cross-sectional view of a connection structure. 10 is pipeline, 28 is screw cap, 29 is C-shaped metal sealing ring, and 30 is threaded valve pipeline inlet and outlet. When the screw cap 28 is tightened to the thread of the valve pipeline orifice 30, the screw cap 28 presses the flange at the end of the pipeline 10, and further presses the C-shaped metal sealing ring 29 to the valve pipeline orifice 30, thus realizing the sealing. The pipeline 10 and the valve pipeline orifice 30 in FIG. 15 can be pre-rotated to any angle, and tightening the screw cap 28 for sealing does not change the angle, which is pretty convenient. In some cases of low cost, the pipeline 10 and the screw cap 28 are made into one component, then the valve pipeline orifice 30 may be rotated to an unexpected angle when tightened for sealing, and since it is rotary pressing, the air-tightness effect of the sealing will be generally poor, but the cost will be lower.

The valve pipeline orifice 30 in FIG. 15 can also be the orifice of another pipeline, as such, the pipeline length can be extended, and the pipeline interface can maintain good air-tightness.

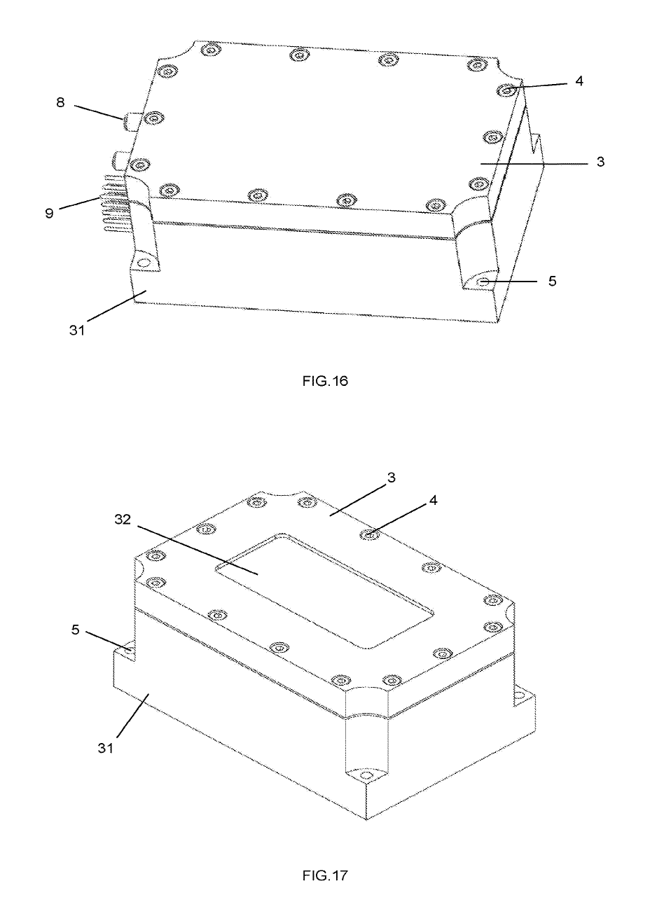

FIG. 16 is a schematic diagram of the structure of the housing of a high air-tightness electromechanical device with no windows of the present invention. FIG. 16 is different form FIG. 1 in that: the bottom plate 1 and the frame wall 2 are integrally formed into a bottom frame 31, without window 6, or pipeline 10. The housing of the electromechanical device is suitable for electrical signal processing device.

FIG. 17 is a schematic diagram of the structure of the housing of a high air-tightness electromechanical device with solar charging or wireless charging. FIG. 17 is different form FIG. 1 in that: the bottom plate 1 and the frame wall 2 are integrally formed into a bottom frame 31, without electrode. The window 32 is disposed on the lid 3, and the power supply can be externally charged by solar charging or wireless charging.

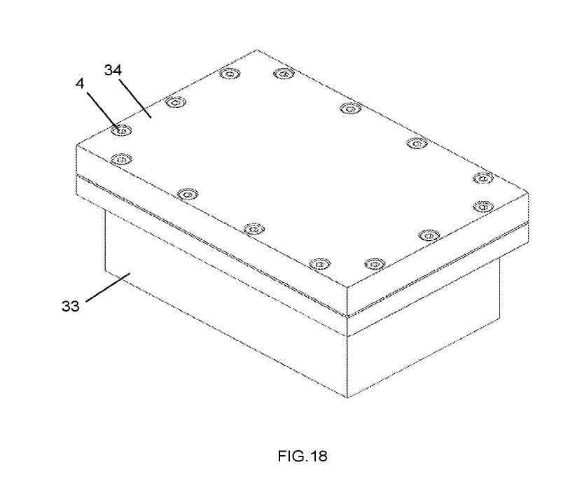

FIG. 18 is a schematic diagram of the structure of the housing of a high air-tightness electromechanical device with a thin-walled frame. FIG. 18 is different form FIG. 1 in that: the bottom plate 1 and the frame wall 2 are integrally formed into a bottom frame 33, and its lower part is a thin-walled frame chassis structure, which saves material and has light weight. 34 is lid.

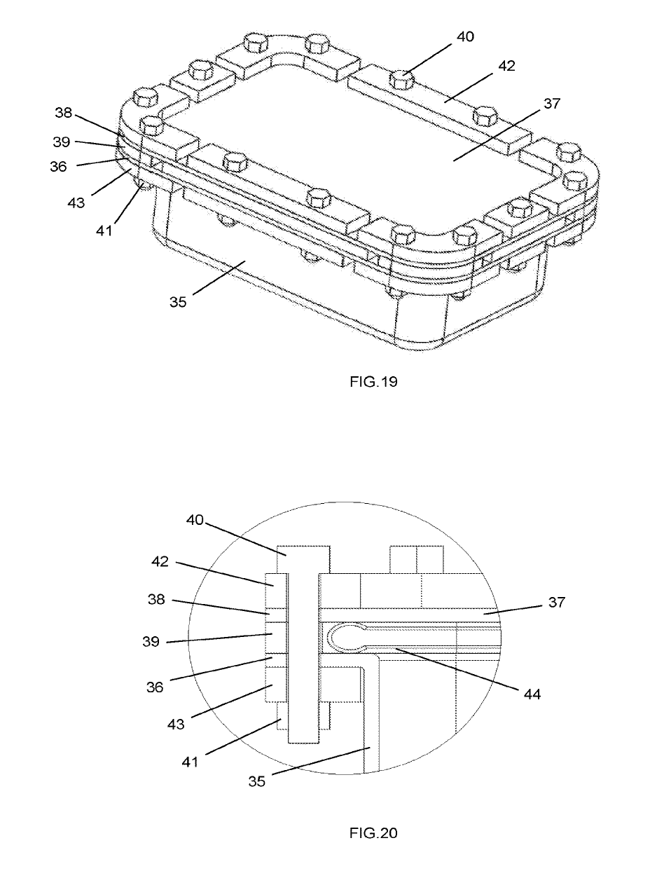

For the housing of a large high air-tightness electromechanical device with the size being more than half a meter, the housing can be made of sheet metal and sheet metal stamping components, and the cost is much lower when compared with machined by thick metal plate milling machine. FIG. 19 is a schematic diagram of the structure of the high air-tightness device made of sheet metal and sheet metal stamping components of the present invention. FIG. 20 is a cross-sectional view showing the sealing structure of FIG. 19. 35 is basin body of the sheet metal stamping component, 36 is flange of the basin body. 37 is lid plate of the sheet metal, 38 is edge of the lid plate. 39 is pressing limiting base plate of the hollow-core metal sealing ring, which can be made of metal material. 40 is bolt used for pressing, 41 is nut used for pressing, 42 is base plate used for the bolt, 43 is bas plate used for the nut. 44 is C-shaped hollow-core metal sealing ring.

When the bolt 40 and nut 41 are tightened, the flange 36 and edge 37 press the C-shaped hollow-core metal sealing ring 44, for sealing. Due to the use of pressing limiting base plate 39, the pressing amounts around the C-shaped hollow-core metal sealing ring 44 are uniform, so as to ensure a good sealing. in addition, due to the internal stress, the flanges of the large basin body may not be in a plane, thus generating warping. In order to adapt to the warping, the pressing limiting base plate 39, the base plate used for the bolt 42, and the base plate used for the nut 43 do not use large whole plates, but divide them into several small segments. These small segments and the edge 37 of the soft sheet metal together can be well adapted to the warping of the flange of the basin body. The shape of the small segments can be long strip, arc, circle, rectangle, etc. The pressing limiting base plate 39 can be fixed with the basin body flange 36, for example, by screw, beforehand, so as to reduce the workload of the final assembly, and can also be integrally formed into one component with the base plate used for the bolt 42, or the base plate used for the nut 43, so as to reduce the number of components.

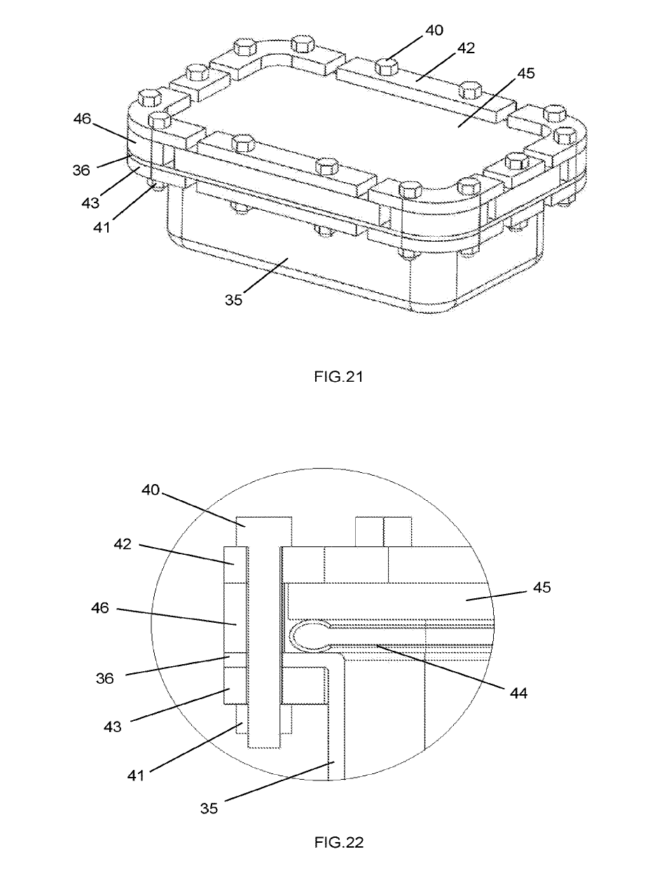

Sometimes it is desired that the housing of the high air-tightness device has a large transparent window so that the article condition inside of the housing can be seen clearly. At this time, the sheet metal 37 of FIG. 19 can be replaced with a glass plate, as shown in FIG. 21. Here, the material of the glass plate or the window glass is an inorganic transparent material, such as glass material, quartz crystal, gem crystal, etc. Because it is not easy to punch holes in the glass, and the glass plate is prone to crush when suffering great pressure, the schematic view of the sealing structure is changed into FIG. 22. In FIGS. 21 and 22, 45 is window glass plate. 46 is pressing limiting base plate of the hollow-core metal sealing ring. Because it is difficult for the glass plate 45 to deform so as to adapt to the warping of the basin body flange 36, when manufacturing the basin body, the warping of the basin body flange 36 should be controlled. below a certain amount, and the width of the flange 36 as well as the thickness of the glass plate 45 should be appropriately increased. As such, the glass plate 45 can resist warping, so that the warping can adapt to the flatness of the glass plate 45. If the pressing limiting base plate 46, the base plate used for the bolt 42, and the base plate used for the nut 43 are also controlled in good flatness, and are not divided into small segments, they are also conducive to resisting warping. The pressing limiting base plate 46 can be fixed with the basin body flange 36, for example, by screw, beforehand, so as to reduce the workload of the final assembly, and can also be integrally formed into one component with the base plate used for the bolt 42, or the base plate used for the nut 43, so as to reduce the number of components.

As for the high air-tightness device in FIGS. 18, 19 and 21, because of the use of thin plate, it is difficult to punch a thread blind hole on it. Therefore, a threaded component can be fixed on the inner wall of the thin plate by adhesives, welding, and ceramic sinter forming and other processing techniques. Also, one or more of the glass window, pipeline, thick electrode and fine electrode communicating the inside with the outside can be fixed on the inner wall of the thin plate by metal solder welding processing technique, metal welding processing technique, glass welding processing technique and ceramic sinter forming processing technique, etc., which not only increases the number of functions, but also maintains a good sealing performance.

The housing of the high air-tightness device of the present invention is not limited to the rectangular shape shown in the above figures, but also can be a complex shape such as a cylinder and an elliptic cylinder, for example, the lid is round and the bottom plate is square. In addition, the bottom plate and the lid are not limited to the plane, but can also be an uneven complex curved surface. In addition, any one of the bottom plate, frame wall and lid can also be composed of a plurality of components, and uses one or more of metal solder welding processing technique, metal welding processing technique, glass welding processing technique, ceramic sinter forming processing technique and hollow-core metal sealing ring pressure seal processing technique for seal connection.

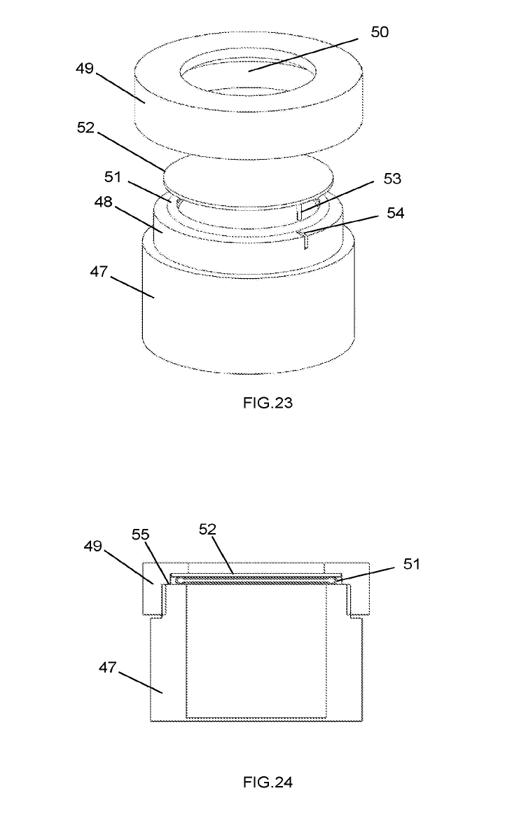

FIG. 23 is an exploded view of a high air-tightness container of the present invention. FIG. 24 is a cross-sectional view after assembly. The container is mainly composed of a container body 47 and a lid 49. The container body 47 has an external threaded opening and an external thread 48. The lid 49 has an internal thread 50, which is matched with the external thread 48. In order to maintain a high air-tightness seal, the present invention uses a hollow-core metal sealing ring 51 and a gasket 52. When the lid 49 is rotated to tighten, the hollow-core metal sealing ring 51 and the gasket 52 are pressed through the propulsion of the external thread 48 and the internal thread 50. The gasket 52 is provided with a key 53, the external threaded opening is provided with a groove 54 and their matching allows the gasket 52 not to rotate with the lid 49, and defines that the container body 47, the hollow-core metal sealing ring 51 and the gasket 52 only have straight pressing, without relative rotation. Thus the hollow-core metal sealing ring 51 is not prone to be worn, and the sealing effect is good. If the lid 49 and the gasket 52 are integrally formed into one component, the cost will be lower, but the hollow-core metal sealing ring 51 will have a rotating wear. 55 is positioning contact surface of the container body 47 and the lid 49, limiting the pressing amount of the hollow-core metal sealing ring 51 not to be excessive. As for the sealing shown in FIG. 24, the components isolating the inside from the outside of the container are container body 47, gasket 52 and hollow-core metal sealing ring 51. Therefore, the materials made of the container body 47 and the gasket 52 should be one or more of metal, glass and ceramic with high air-tight performance.

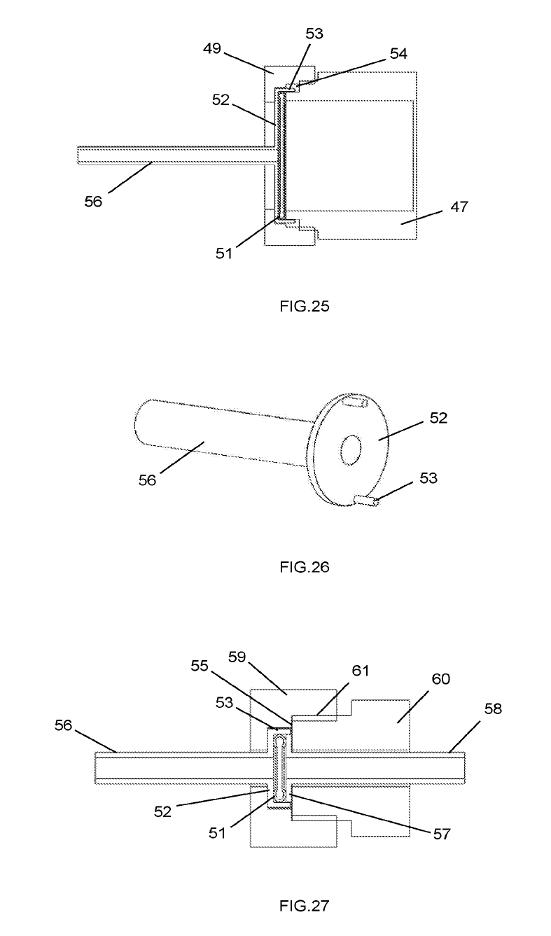

FIG. 25 shows that a pipeline 56 is provided on the gasket 52. This pipeline 56 can be formed by machined with the gasket 52 together and can also be sealed by metal solder welding processing technique, metal welding processing technique, glass welding processing technique, ceramic sinter forming processing technique, and hollow-core metal sealing ring pressure seal processing technique. The status of the key 53 inserted into the groove 54 is also shown. The shape of the key 53 can be cylinder, cuboid, etc., the key 53 can be integrally formed with the gasket 52, or can be re-assembled by different components, or can be assembled before the lid 49 is tightened at the end of the separation. The groove 54 can be a square groove, and can also be a round hole, etc. FIG. 26 is a perspective view showing the gasket 52 with a pipeline 56 and a key 53.

The gasket 52 can also have a through electrode, the inner side of the high air-tightness container is provided with an electronic component, through the electrode, power is supplied and signal is input from the external, and then the signal is output from the inside to the outside. The sealing method for the electrode can be the same as the sealing method for the pipeline. Similarly, the container body 47 can also be provided with a pipeline, an electrode and a window glass, etc.

FIG. 27 shows a schematic diagram of the structure of the high air-tight butt joint of the two pipelines through the pressing of the hollow-core metal sealing ring. The two sides of the hollow-core metal sealing ring 51 are respectively provided with gaskets 52 and 57 having pipelines. The gaskets 52 and 57 may also be the flanges of the ends of the pipelines 56 and 58, respectively. The gasket 52 is provided with a key 53, and the gasket 57 is provided with a groove. The gasket 52 can be separated from the key 53 and is made to be the same as the groove on the gasket 57, and at this time the key 53 is just a cylinder or a cuboid. Because of the matching of the key 53 and the groove, the gaskets 52, 57 arid the hollow-core metal sealing ring 51 do not have relative rotation, but only have straight pressing and separating, so as to avoid the rotary friction of the hollow-core metal sealing ring 51, thus improving sealing performance. 59 is hollow screw nut having an internal thread, 60 is hollow screw bolt having an external thread, the internal and external threads are rotating matched at 61, pressing the gaskets 52, 57 and the hollow-core metal sealing ring 51. The positioning contact surface 55 defines the pressing amount of the hollow-core metal sealing ring 51. Compared with the rotary pressing of FIG. 15, the sealing performance of the straight pressing of FIG. 27 is better.

In some cases, two high air-tightness electromechanical devices need to be connected together through the pipeline. For example, air conditioning refrigerant compressor and air conditioning radiator generally need to be connected together through the pipeline. The high air-tightness sealing method of pipeline interface connection of the present invention has good high- and low temperature performance, durability, and better air-tightness than the sealing method of the pipeline socket connection and the rubber ring sealing method for the air-conditioning pipeline used in buildings and vehicles.

The high air-tightness device of the present invention can be a sealing device of a high temperature heating furnace. The housing of the high temperature heating furnace is composed of a frame wall and a lid etc., the sealing between them usually adopts the rubber ring. The heat-resistance temperature of rubber ring material is generally below 500° C., if the heating temperature reaches more than 1000° C., the use of rubber ring to seal will become difficult. The cooling water pipeline can be disposed around the rubber ring for cooling, but the use of hollow-core metal sealing ring with a higher heat-resistance temperature to seal can allow the structure to be more simple.

Similarly, as for ultra-low temperature cooling device, such as liquid nitrogen cooling device with the temperature of −196° C., the resistance to low temperature of conventional rubber ring and other organic materials is much higher than −196° C. in this case, the use of hollow-core metal sealing ring with resistance to extremely low temperature for sealing is better.

The high air-tightness device related to the present invention is applicable in laser, lighting source, camera, video camera, computer, database storage, telephone, oscilloscope, multimeter, communication equipment, electrical signal processor, microwave component, sensor, air conditioner, high temperature heating furnace, ultra-low temperature cooling device and long-term oxidation preventive preservation device and other uses.

The embodiment is not intended to limit the shape, material and structure of the present invention in any form, and any simple modification, equivalent change and decoration made to the above embodiments on the basis of the technical essence of the present invention all fall within the scope of protection of the technical solution of the present invention.

1. High air-tightness device comprising:
bottom plate, frame wall and lid components forming sealed container, and hollow-core metal sealing ring,
wherein said components press said metal sealing ring in a plane to make sealing with threaded components in one or more junctions between said components,
while other junctions between said components are sealed in advance during pre-assembly or pre-forming by using one or more of metal solder welding processing technique, metal welding processing technique, glass welding processing technique, and ceramic sinter forming processing technique,
and one or more of said components are metal material, or glass or ceramic material with pre-plated or pre-welded metal material in contact surfaces pressing said metal sealing ring.

2. High air-tightness device according to claim 1, wherein said bottom plate, frame wall and lid are provided with one or more of window glass, pipeline and thick electrode and tine electrode communicating inside with outside, the materials of these components and of the junctions with said bottom plate, frame wall or lid are one or more of metal, glass and ceramic, and said junctions are sealed in advance during pre-assembly or pre-forming by using one or more of the metal solder welding processing technique, metal welding processing technique, glass welding processing technique, ceramic sinter forming processing technique and hollow-core metal sealing ring pressing sealing technique.

3. High air-tightness device according to claim 1, wherein said bottom plate and said frame wall are an integrally formed component, or said frame wall and said lid are an integrally formed component.

4. High air-tightness device according to claim 1, wherein one or more of said bottom plate, frame wall and lid comprise one or more of internal threaded blind hole and external threaded blind hole which are used for installation of internal and external elements and components.

5. High air-tightness device according to claim 1, wherein comprises pipeline interface with external thread and internal threads of metal material and hollow-core metal sealing ring,
and said device uses said external thread and internal thread to propel moving components in a straight or rotary manner, and uses plane to press said hollow-core metal sealing ring, to perform connection sealing of said pipeline interface.

6. High air-tightness device comprising:
an openable and closable valve, wherein the materials of each component for isolating inside from outside of said valve when said valve is closed are one or more of metal, glass and ceramic with pre-plated or pre-welded metal material in contact surfaces pressing hollow-core metal sealing ring, and said device uses external thread and internal thread to propel or electrically propel moving components of said valve in a straight or rotary manner, and uses plane to press or loosen said hollow-core metal sealing ring inside of said valve, in order to close or open said valve.

7. High air-tightness device according to claim 6, wherein said valve comprises a rubber ring, and when said valve is opened hermetically, said rubber ring is used for temporary sealing.

8. High air-tightness device according to claim 6, wherein said valve comprises a knob switch, by loosening said switch, said hollow-core metal sealing ring is taken out from said valve.

9. High air-tightness device according to claim 1, wherein comprises sheet metal component, sheet metal stamping component, glass plate component which is pre-plated or pre-welded with metal material in contact surfaces pressing hollow-core metal sealing ring, hollow-core metal sealing ring and pressing amount limiting base plate,
and two of said components press and seal said hollow-core metal sealing ring with threaded components, as the packaging for sealed container,
and said pressing amount limiting base plate limits the pressing amount of said hollow-core metal sealing ring.

10. High air-tightness device according to claim 9, wherein said pressing limiting base plate is a whole plate, or several base plates with minor segments, and integrally pre-fixed with said sheet metal component, sheet metal stamping component or glass plate prior to pressing sealing.

11. High air-tightness device comprising:
external or internal threaded opening component, hollow-core metal sealing ring,
wherein said opening components use the internal and external thread to press said hollow-core metal sealing ring by a plane to form a sealed container,
and the materials of said container components for isolating inside from outside of the container when sealing are one or more of metal, glass and ceramic which is pre-plated or pre-welded with metal material in contact surfaces pressing said metal sealing ring.

12. High air-tightness device according to claim 11, wherein comprises gaskets of metal, glass and ceramic which is pre-plated or pre-welded with metal material in contact surfaces pressing said metal sealing ring in one or more of the positions between said external or internal threaded opening components and said hollow-core metal sealing ring, and between said hollow-core metal sealing ring and said corresponding internal or external threaded components.

13. High air-tightness device according to claim 11, wherein comprises keys or grooves in one or more of the positions between said external or internal threaded opening components, said gaskets and said corresponding internal or external threaded components,
and through the matching of said keys and grooves, when said external or internal threaded opening components and said corresponding internal or external threaded components are rotated to tighten or loosen, said gaskets and said hollow-core metal sealing ring only have straight motion of pressing or leaving, and have no relative rotation.

14. High air-tightness device according to claim 12, wherein said gaskets are edges of pipeline.

15. High air-tightness device according to claim 11, wherein said external or internal threaded opening is one or more of threaded opening of bottle or tank container, threaded orifice of pipeline, inlet of electrode and mounting opening of window glass.

16. High air-tightness device according to claim 11, wherein said external or internal threaded opening component is the component of a pipeline having edges in addition to a hollow screw thread.

17. High air-tightness device according to claim 2, wherein the sealing process of said pipeline outside said device is heating to melt, clamping off, or connecting said valve to close.

18. High air-tightness device according to claim 1, wherein said hollow-core metal sealing ring is one or more of C-shape, spring-enhanced C-shape, E-shape, W-shape, O-shape, U-shape and V-shape.

19. High air-tightness device according to claim 1, wherein one or more of vacuum, special gas, nitrogen, inert gas, refrigerant gas and liquid, liquid and laser gain medium are sealed within said device.

20. High air-tightness device according to claim 1, wherein two or more of said high air-tightness devices are connected and sealed through the use of hollow-core metal sealing ring for pipeline or valve.
